(19) United States
(12) Patent Application Publication
(10) Pub. No.: US 2008/0060237 A1
(43) Pub. Date: Mar. 13, 2008

(54) Neon simulated phosphor illuminating sign

(76) Inventors: John Chiang, Oceanside, CA (US); Ken-Sheng Chiang, Oceanside, CA (US)

Correspondence Address: Raymond Y. Chan, Suite 128, 108 N. Ynez Avenue, Monterey Park, CA, 91770, US

(21) Appl. No.: 11/786,965

(22) Filed: Apr. 13, 2007

Related U.S. Application Data
(60) Provisional application No. 60/843,458, filed on Sep. 8, 2006.

(51) Int. Cl. G09F 13/04

(52) U.S. Cl. 40/564

(57) ABSTRACT

An illumination sign includes a sign panel, a light source, and a simulated neon illumination arrangement. The light source is mounted at a rear side of the sign panel to provide illumination toward the sign panel. The simulated neon illumination arrangement includes a light blocking layer provided on the rear surface of the sign panel at the background portion thereof, and a neon effect illumination film provided on the sign panel at the sign portion thereof to form a sign character, wherein when the light source generates light towards the rear side of the sign panel, a portion of the light impinging on the sign portion is allowed to pass through the sign portion through the neon effect illumination film to illuminate the sign characters for producing a simulated neon illumination effect.

### CROSS REFERENCE OF RELATED APPLICATION This is a non-provisional application of a provision application having an application number of 60/843,458 and a filing date of Sep. 8, 2006.

### BACKGROUND OF THE PRESENT INVENTION

1. Field of Invention

The present invention relates to a neon simulated phosphor illuminating sign and a manufacturing method thereof.

2. Description of Related Arts

A commonly called “neon sign” is usually made up of a sign or a plurality of bend-worked gas-discharge tubes of glass. As a matter of course, a gas-discharge tube must be constituted by a continuous discharge path, therefore, if a sign pattern, as is often the case, consists of a plurality of pattern-constituting elements, the pattern must be constituted either with a plurality of gas-discharge tubes or with a partially light-shielded single gas-discharge tube. The use of many discharge tubes results in the complexity of tube arrangements and electric wirings, whereas partial light shielding, practiced usually with bad-looking opaque bandage or coatings applied to the tube, injures the beauty of the neon sign, particularly in the daytime when the neon sign is kept non-luminous. Besides, the gas-discharge tubes themselves are not only fragile but also unsuitable for the mass-production of the same-patterned neon sign.

The drawbacks of conventional neon sign: need neon light tube, complicated structure, high cost, and so on. Such as described in U.S. Pat. No. 5,992,067 issued Nov. 30, 1999 to Ryan Kromholz; and 7,024,808 issued Apr. 11, 2006 to Raymond Y. David; the use of neon sign is disclosed.

Another patent reference of interest is U.S. Pat. No. 4,891,896 issued Jan. 9, 1990 to Donovan. This prior art Simulated neon sign comprises a frame, non-neon internal lighting, and a front plastic panel having an outer face. Although this device may present some advantages over the incandescent sign devices noted above, this type sign (design) is flawed in that such non-neon internal lighting can result in noticeable internal lighting burnout(s).

Other prior art patents of interest include: U.S. Pat. No. 4,976,057 issued Dec. 11, 1990 to Lyon; There is disclosed herein a new form of sign or graphic display which simulates a neon sign. The same comprises a hollow tube or tubes which are formed into desired shapes.

The above noted patents are mentioned as being representative of the prior art and other pertinent references may exist. None of these patents are deemed to affect the patentability of the present claimed invention.

### SUMMARY OF THE PRESENT INVENTION

A main object of the present invention is to provide an illumination sign which is capable of simulating a neon light illumination effect without utilizing harmful substances which are employed in conventional neon light.

Another object of the present invention is to provide an illumination sign comprising a simulated neon illumination arrangement which comprises a light blocking layer and a neon effect illumination film provided on a sign panel for simulating a neon light effect to predetermined sign characters as though the light effect is from a conventional neon light.

Another object of the present invention is to provide an illumination sign which does not involve complicated and expensive components so as to minimize the manufacturing cost of the present invention. Moreover, the present invention is easy to manufacture as compared with conventional neon signs.

It is an object of the present invention to provide an improved illumination sign panel for solving previous problem.

Another object of the present inventions is to provide a new and improved sign panel.

Accordingly, in order to accomplish the above objects, the present invention provides an illumination sign, comprising:

a sign panel which has a front displaying surface at a front displaying side, and a rear surface at a rear side of the sign panel;

a light source mounted at a rear side of the sign panel to provide illumination toward the rear surface of the sign panel; and

an simulated neon illumination arrangement, which comprises:

a light blocking layer provided on the rear surface of the sign panel to form a background portion of the sign panel which is light-inadmissible from the light source; and

a neon effect illumination film formed on the sign panels to define a plurality of sign portions of the sign panel forming a corresponding number of sign characters at the sign portions respectively, wherein when the light source generates light towards the rear side of the sign panel, a portion of the light impinging the background portion is blocked from reaching the front displaying side, while a portion of the light impinging on the sign portions is allowed to pass through the sign portions through the neon effect illumination film to illuminate the sign characters with a simulated neon illumination effect as viewed on the front displaying side of the sign panel.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a neon simulated phosphor illuminating sign according to a preferred embodiment of the present invention.

FIG. 2 is a front perspective view of a sign panel according to the above preferred embodiment of the present invention.

FIG. 3 is a rear perspective view of the sign panel according to the above preferred embodiment of the present invention.

FIG. 4 is a sectional side view of the neon simulated phosphor illuminating sign according to the above preferred embodiment of the present invention.

### DETAILED DESCRIPTION OF THE PREFERRED EMBODIMENT

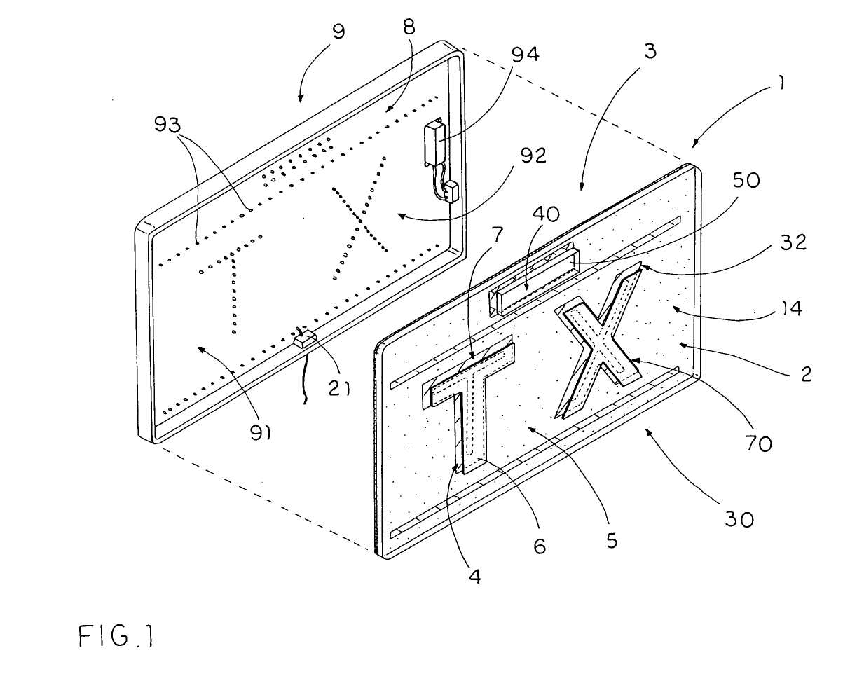

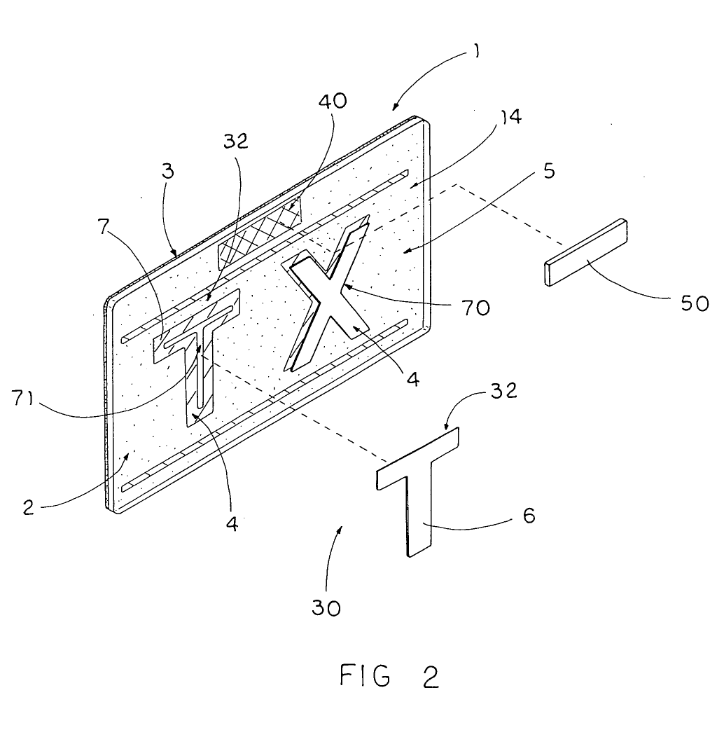

Referring to FIGS. 1 to 4 of the drawings, the front and rear view of a sign panel 1 is presented. The sign panel 1 is made of either transparent or translucent light transmitting material for light passing from one side to another opposite side. The sign panel 1 has a front displaying side 2 and rear side 3. The front displaying side 2 of the panel has two portions: the sign portion 4 and the background portion 5. The sign portion 4 forms a sign character 70. The front displaying side 2 of the sign character 70 is printed with any color and phosphor coating on the outside. The image on the outside surface represents the original artwork or neon design. The rear side 3 of the sign character 70 is printed with phosphor coating, and with outline that extends 2 mm off the original graphic printed on the front printing area. Both sides of the background portion 5 of the sign panel 1 are printed with clear acrylic to block the light passing therethrough so as to define the sign character 70 at the sign portion 4. In addition, a light blocking film 11 is coated at the rear side 3 of the sign panel 1 at the background portion 5 thereof for blocking the light passing from the rear side 3 to the front side 2.

The sign panel 1 further comprises a front shading layer 6 shaped corresponding to the sign character 70. The front shading layer is phosphor coating. The front shading layer 6 is attached to the front displaying side 2 to create a front shading effect of the sign character 70, wherein a width of the front shading layer 6 is smaller than a width of the sign portion 4 such that a surrounding edge of the sign portion 4 of the sign panel 1 is adapted for allowing the light passing through to create a 3-D effect. In other words, the front shading layer creates a “floating” effect on the sign panel 1 to create a 3-D effect of the sign character 70.

The sign panel 1 further comprises a base shading layer 7 shaped corresponding to the sign character 70. The base shading layer is attached to the rear side of the sign portion of the sign panel 1, wherein the base shading layer 7 has a center light passing portion 71 aligned with a center portion of the sign character 70 for allowing the light passing towards the sign panel 1.

The front and base shading layers 6, 7 has a light transmission ability lower than that of the sign panel 1 to create the shading effect of the sign character 70.

Therefore, by the configuration of the thickness of the sign panel 1, the front shading layer 6, and the base shading layer 7, the sign character 70 forms a 3-D neon illuminating effect when the light passing from the rear side of the sign panel 1 to the front side thereof.

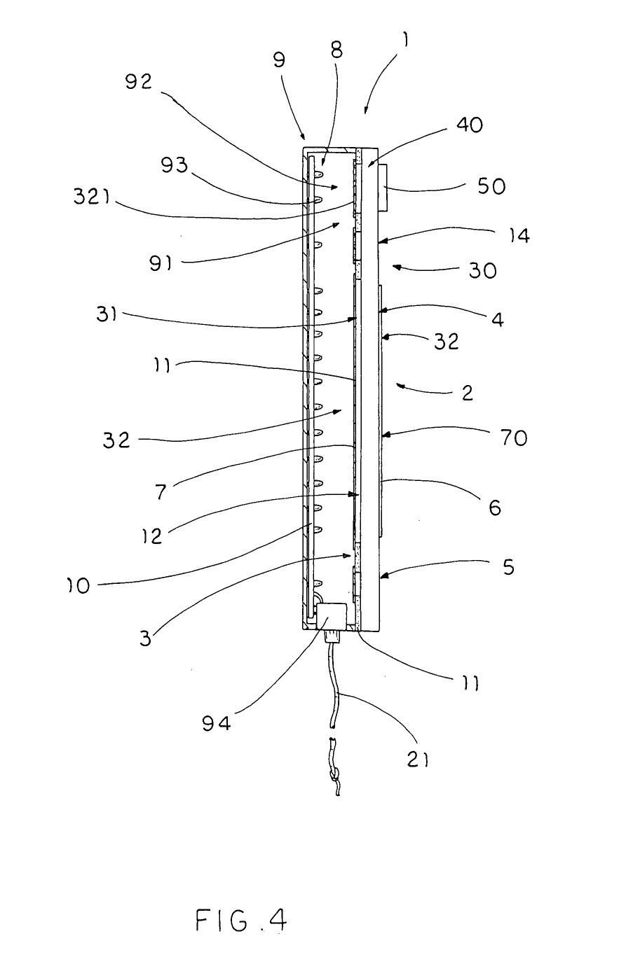

Referring to FIGS. 1 and 4 of the drawings, the side and back view of the illuminating sign panel 1 is presented. The light housing 9 is a thermal forming injection mold light housing 9. The light housing 9 houses a light source 8 therein to electrically connect to a power source. The light source 8 can comprise a plurality of LEDs to generate the light towards the rear side of the sign panel 1. No neon light is required. The LED is attached with specified crystals to produce the intense illumination that matches the ultraviolet wave length of the phosphor coating on the printed panel. For LED configuration, a circuit board 10 is required to electrically connect and support the LEDs in the light housing. In addition, the LEDs are supported and aligned to the sign character 70.

To describe the present invention in a more specified manner, referring to FIG. 1 to FIG. 4 of the drawings, an illumination sign according to a preferred embodiment of the present invention is illustrated, in which the illumination sign comprises a sign panel 1 having a predetermined thickness, a light source 8, and a simulated neon illumination arrangement 30.

The sign panel 1 has a front displaying surface 14 formed at a front displaying side 2, and a rear surface 12 formed at the rear side 3 of the sign panel 1.

The light source 8 is mounted at a rear side 3 of the sign panel 1 to provide illumination toward the rear surface 12 of the sign panel 1.

The simulated neon illumination arrangement 30 comprises a light blocking layer 31 provided on the rear surface 12 of the sign panel 1 to form on the background portion 5 of the sign panel 1 which is light-inadmissible from the light source 8, and a neon effect illumination film 32.

The neon effect illumination film 32 is formed on the sign panel 1 to define a plurality of sign portions 4 of the sign panel 1 forming a corresponding number of sign characters 70 at the sign portions 4 respectively, wherein when the light source 8 generates light towards the rear side 3 of the sign panel 1, a portion of the light impinging on the background portion 5 of the sign panel 1 is blocked from reaching the front displaying side 2, while a portion of the light impinging on the sign portions 4 is allowed to pass through the sign portions 4 through the neon effect illumination film 32 on the rear surface 12 to illuminate the sign characters 70 with a simulated neon illumination effect as viewed on the front displaying side 2 of the sign panel 1.

According to the preferred embodiment of the present invention, the sign panel 1 is sharply and accurately cut by laser techniques to form a predetermined shape and size for displaying the sign characters 70.

The light source 8 comprises a light housing 9 having a receiving cavity 91 and a front opening 92 communicating with the receiving cavity 91, a plurality of illumination units 93, such as LEDs, spacedly mounted within the receiving cavity 91 to generate illumination towards the front opening 92, and a power supply 94, mounted in the receiving cavity 91 and electrically connected with the illumination units 93 for electrically connecting the illumination units 93 with an external source, such as an external AC power supply. It is worth mentioning that a cross section of the light housing 9 is substantially the same as the cross section of the sign panel 1 so that the sign panel 1 is adapted to be fittedly mounted to the light housing 9 for effectively illuminating the sign characters 70 by the illumination provided from the illumination units 93.

According to the preferred embodiment of the present invention, the illumination units 93 are a plurality of LEDs generating the light with a wavelength matching with an excited wavelength of the neon effect illumination film 32 to create the simulated neon illumination effect, wherein the illumination units 93 are arrayed within the receiving cavity 91 to align with the sign portion 4 of the sign panel 1 to directly project the light thereto.

The light blocking layer 31 of the simulated neon illumination arrangement 30 comprises a light-inadmissible light blocking film 11 coated on the rear surface 12 at the rear side 3 of the sign panel 1 for forming the background portion 5 of the sign panel 1. It is important to point out that the light blocking film 11 is not coated on the entire rear surface 12 of the sign panel 1, but only the portion of the rear surface 12 on which the sign characters 70 are not formed, i.e. the background portion 5.

According to the preferred embodiment of the present invention, the light blocking film 11 is black in color which is adapted to block light coming from the illumination units 93 to penetrate the rear surface 12 of the sign panel 1 so as to keep the background portion 5 of the sign panel 1 plain and prevent it from being illuminated. In other words, the light blocking film 11 is arranged to prevent penetration of light coming from the light source 8 through the sign panel 1 except through the sign characters 70.

On the other hand, the neon effect illumination film 32 comprises a plurality of front and base shading layers 6, 7 coated on the front displaying surface 14 and the rear surface 12 at each of the sign portions 4 of the sign panel 1 respectively so as to provide the simulated neon illumination effect of the present invention. More specifically, each of the front shading layer 6 is coated on a central section of the corresponding sign character 70 on the front displaying surface 14, such that when the light projects towards the sign portion 4 at the front displaying side 2 of the sign panel 1, the light not only impinges on the front shading layer 6 to create the simulated neon illumination effect but also impinges a peripheral edge section of the sign portion 4 of the sign panel 1 at the front displaying side 2 to create a three-dimensional floating effect of the sign characters 70.

On the other hand, each of the base shading layers 7 is alignedly provided along a peripheral section of the sign portion 4 of the sign panel 1 such that when the light projects towards the sign portion 4 at the rear side 3 of the sign panel 1, the light not only impinges on the base shading layer 7 to create the simulated neon illumination effect but also impinges a center section of the sign portion 4 of the sign panel 1 at the rear side 3 to create a three-dimensional floating effect of the sign character 70.

It is particularly important to mention that the front and the base shading layers 6, 7 are embodied as ultraviolet ray phosphor layers which will be fully excited and activated under the condition that they are hit by ultraviolet radiation. Accordingly, each of the illumination units 93 is arranged to generate illumination and produce ultraviolet radiation toward the sign panel 1 for activating the front and base shading layers 6, 7. According to the preferred embodiment of the present invention, each of the front and base shading layers 6, 7 is white in color for contrasting the sign characters 70 with the dull background portion 5 of the sign panel 1.

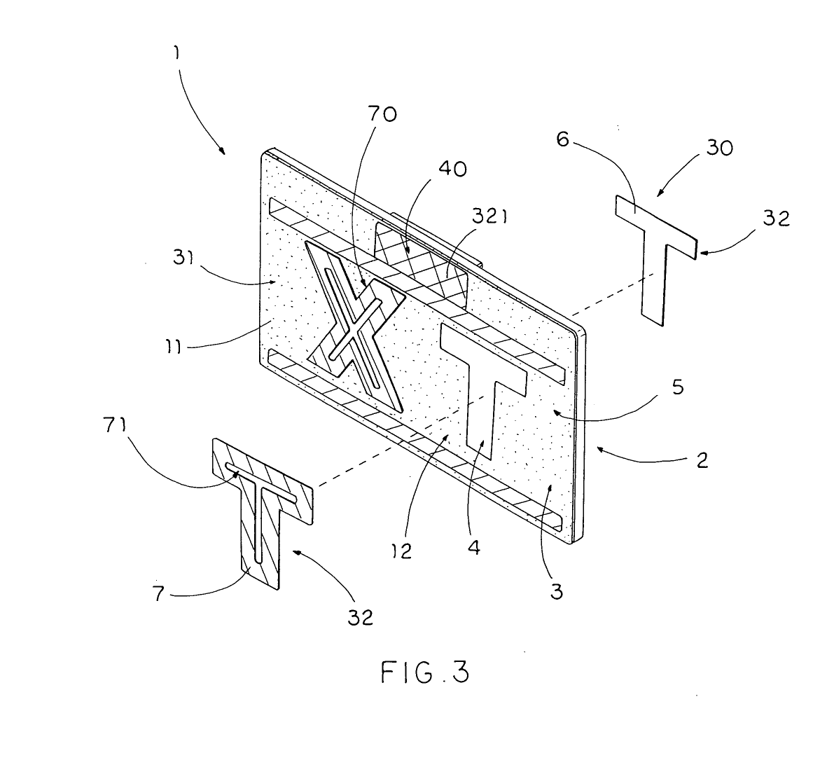

Furthermore, the sign panel 1 further has decorative portion 40, wherein the neon effect illumination film 32 further comprises a decorative highlighting layer 321 (as shown in FIG. 3 of the drawings) which is provided on the rear side 3 of the sign panel 1 at the decorative portion 40 and is arranged when the light projects through the decorative portion 40, the decorative highlighting layer 321 creates a highlighting effect to enhance an overall aesthetic effect of the corresponding sign character 70.

In order to enhance the decorative effect of the decorative portion 40, illumination sign further comprises a decorative sign 50 overlappedly attached onto the decorative portion 40 of the sign panel 1 on the front displaying side 2 thereof, wherein the decorative sign 50 is light admissible having a predetermined light admissibility so that when the light from the light source 8 passes through the decorative sign 50, it generates an enhanced decorative effect of the present invention.

It is worth mentioning the transmissivity of light of the decorative highlighting layers 321 is pre-arranged to fit particular aesthetic effect. For example, the decorative highlighting layers 321 may be red-colored coating coated onto the rear surface 12 at the decorative portions 40 respectively in such a manner that when light coming from the light source impinges on the decorative highlighting layers 321, they will be illuminated to a predetermined extent (as compared to the sign characters 70) for providing a predetermined aesthetic effect shown from the aesthetic patterns on the sign panel 1. The decorative highlighting layers 321 can also be phosphor layers which can be excited or activated by ultraviolet radiation coming from the illumination units 93.

Finally, the light source 8 further comprises a control switch 21 provided at the light housing 9 to electrically connect with the illumination units 93 and the power supply 94 for selectively controlling an operation of the illumination units 93.

Referring to FIG. 5 of the drawings, a method of manufacturing an illumination sign according to the preferred embodiment of the present invention is illustrated, in which the method comprises the steps of:

(a) vacuuming forming a base panel having a predetermined size and shape;

(b) phosphor coating a plurality of front shading layers 6 and back shading layers 7 on the panel;

(c) laser cutting a top panel into the predetermined size and shape of the base panel;

(d) integrally binding the top panel onto the base panel having the front shading layer 6 at the back shading layer 7 to form sign panel 1 of the illumination sign;

(e) injection molding a light housing 9 and installing a plurality of illumination units 93 into the light housing 9; and

(f) mounting the light housing 9 into a rear side 3 of the sign panel 1 for forming the illumination sign.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An illumination sign, comprising:
a sign panel, having a predetermined thickness, which has a front displaying side and an opposed rear side, wherein said sign panel, which is made of light-admissible material adapted for light passing from said rear side to said front displaying side, further has a sign portion and a background portion;
a light source mounted at a rear side of said sign panel to provide illumination toward said rear surface of said sign panel; and
a simulated neon illumination arrangement, which comprises:
a light blocking layer provided on said rear surface of said sign panel at said background portion of said sign panel which is light-inadmissible from said light source; and
a neon effect illumination film provided at said sign portion of said sign panel to form a sign character thereat, wherein when said light source generates said light towards said rear side of said sign panel, a portion of said light impinging said background portion is blocked from reaching said front displaying side, while a portion of said light impinging on said sign portion is allowed to pass through said sign portion through said neon effect illumination film to illuminate said sign characters with a three-dimensional simulated neon illumination effect as viewed on said front displaying side of said sign panel.

2. The illumination sign, as recited in claim 1, wherein said neon effect illumination film comprises a front shading layer coated on said front displaying side of said sign panel at a position that said front shading layer is alignedly provided along a center section of said sign portion of said sign panel such that when said light projects towards said sign portion at said front displaying side of said sign panel, said light not only impinges on said front shading layer to create said simulated neon illumination effect but also impinges a peripheral section of said sign portion of said sign panel at said front displaying side to create a three-dimensional floating effect of said sign character.

3. The illumination sign, as recited in claim 1, wherein said neon effect illumination film comprises a base shading layer coated on said rear side of said sign panel at a position that said base shading layer is alignedly provided along a peripheral section of said sign portion of said sign panel such that when said light projects towards said sign portion at said rear side of said sign panel, said light not only impinges on said base shading layer to create said simulated neon illumination effect but also impinges a center section of said sign portion of said sign panel at said rear side to create a three-dimensional floating effect of said sign character.

4. The illumination sign, as recited in claim 2, wherein said neon effect illumination film further comprises a base shading layer coated on said rear side of said sign panel at a position that said base shading layer is alignedly provided along a peripheral section of said sign portion of said sign panel such that when said light projects towards said sign portion at said rear side of said sign panel, said light not only impinges on said base shading layer to create said simulated neon illumination effect but also impinges a center section of said sign portion of said sign panel at said rear side to create a three-dimensional floating effect of said sign character.

5. The illumination sign, as recited in claim 2, wherein said front shading layer is ultraviolet ray phosphor layer which is arranged to be fully excited when impinged by ultraviolet radiation.

6. The illumination sign, as recited in claim 4, wherein said front and said base shading layers are ultraviolet ray phosphor layers which are arranged to be fully excited when impinged by ultraviolet radiation.

7. The illumination sign, as recited in claim 1, wherein said light blocking layer of said simulated neon illumination arrangement comprises a light-inadmissible and black colored light blocking film coated on said rear side of said sign panel at said background portion thereof.

8. The illumination sign, as recited in claim 4, wherein said light blocking layer of said simulated neon illumination arrangement comprises a light-inadmissible and black colored light blocking film coated on said rear side of said sign panel at said background portion thereof.

9. The illumination sign, as recited in claim 6, wherein said light blocking layer of said simulated neon illumination arrangement comprises a light-inadmissible and black colored light blocking film coated on said rear side of said sign panel at said background portion thereof.

10. The illumination sign, as recited in claim 1, wherein said light source comprises a light housing, having a receiving cavity and a front opening communicating with said receiving cavity mounted at said rear side of said sign panel, a plurality of illumination units spacedly mounted within said receiving cavity to generate illumination towards said rear side of said sign panel, and a power supply which is mounted in said receiving cavity and is electrically connected with said illumination units for electrically connecting said illumination units with a power source for electrically activating said illumination units to illuminate said sign panel.

11. The illumination sign, as recited in claim 4, wherein said light source comprises a light housing, having a receiving cavity and a front opening communicating with said receiving cavity mounted at said rear side of said sign panel, a plurality of illumination units spacedly mounted within said receiving cavity to generate illumination towards said rear side of said sign panel, and a power supply which is mounted in said receiving cavity and is electrically connected with said illumination units for electrically connecting said illumination units with a power source for electrically activating said illumination units to illuminate said sign panel.

12. The illumination sign, as recited in claim 9, wherein said light source comprises a light housing, having a receiving cavity and a front opening communicating with said receiving cavity mounted at said rear side of said sign panel, a plurality of illumination units spacedly mounted within said receiving cavity to generate illumination towards said rear side of said sign panel, and a power supply which is mounted in said receiving cavity and is electrically connected with said illumination units for electrically connecting said illumination units with a power source for electrically activating said illumination units to illuminate said sign panel.

13. The illumination sign, as recited in claim 10, wherein said illumination units are a plurality of LEDs generating said light with a wavelength matching with an excited wavelength of said neon effect illumination film to create said simulated neon illumination effect.

14. The illumination sign, as recited in claim 11, wherein said illumination units are a plurality of LEDs generating said light with a wavelength matching with an excited wavelength of said neon effect illumination film to create said simulated neon illumination effect.

15. The illumination sign, as recited in claim 12, wherein said illumination units are a plurality of LEDs generating said light with a wavelength matching with an excited wavelength of said neon effect illumination film to create said simulated neon illumination effect.

16. The illumination sign, as recited in claim 12, wherein said illumination units are arrayed within said receiving cavity to align with said sign portion of said sign panel to directly project said light thereto.

17. The illumination sign, as recited in claim 15, wherein said illumination units are arrayed within said receiving cavity to align with said sign portion of said sign panel to directly project said light thereto.

18. The illumination sign, as recited in claim 1, wherein said sign panel further has decorative portion, wherein said neon effect illumination film further comprises a decorative highlighting layer which is provided on said rear side of said sign panel at said decorative portion and is arranged when said light projects through said decorative portion, said decorative highlighting layer creates a highlighting effect to enhance an overall aesthetic effect of said sign character.

19. The illumination sign, as recited in claim 6, wherein said sign panel further has a decorative portion, wherein said neon effect illumination film further comprises a decorative highlighting layer which is provided on said rear side of said sign panel at said decorative portion and is arranged when said light projects through said decorative portion, said decorative highlighting layer creates a highlighting effect to enhance an overall aesthetic effect of said sign character.

20. The illumination sign, as recited in claim 17, wherein said sign panel further has a decorative portion, wherein said neon effect illumination film further comprises a decorative highlighting layer which is provided on said rear side of said sign panel at said decorative portion and is arranged when said light projects through said decorative portion, said decorative highlighting layer creates a highlighting effect to enhance an overall aesthetic effect of said sign character.
